(19) United States
(12) Patent Application Publication
(10) Pub. No.: US 2007/0178284 A1
(43) Pub. Date: Aug. 2, 2007

(54) DRINKING GLASS COVER

(76) Inventor: Gregory M. Barry, Hanover, MA (US)

Correspondence Address: ALTMAN & MARTIN, 6 BEACON ST, STE 600, BOSTON, MA, 02108, US

(21) Appl. No.: 11/618,973

(22) Filed: Jan. 2, 2007

Related U.S. Application Data
(60) Provisional application No. 60/764,526, filed on Feb. 2, 2006.

(51) Int. Cl. B32B 23/02

(52) U.S. Cl. 428/192

(57) ABSTRACT

A drinking glass cover comprised of a thin film on a carrier. The film is composed of either a material that clings to smooth surfaces or a material coated with a weak adhesive to remain adhered over the opening of a glass. Optionally, the film material retains its integrity when pierced by a straw or has a straw opening. Optionally, the film material loses its integrity when pierced. Optionally, the film has a tab for easy removal from the carrier. The carrier is a paper, cardboard, or plastic panel to which the film is adhered. Optionally, the carrier is score to facilitate removal of the film. Optionally, carriers are attached to each other in a roll. Optionally, the carriers are detachable from the roll. Optionally, the carrier has a surface coating or layer that facilitates adherence and/or release by the film. Optionally, the carrier can be designed to be used as a coaster before or after the film is removed. Optionally, the carrier and/or film is imprinted.

### CROSS-REFERENCES TO RELATED APPLICATIONS

The applicant wishes to claim the benefit of U.S. Provisional Patent Application No. 60/764,526, filed Feb. 2, 2006, for COCKTAIL GLASS COVER in the name of Gregory Barry.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to protective devices, more particularly, to devices to protect drinks in public places.

2. Description of the Related Art

Two concerns with drinks in bars, lounges, dance clubs, etc., are spillage and the introduction of foreign substances into drinks. A glass sitting on a table or bar can end up with, for example, cigarette ashes, in it. Much worse is the threat of “date rape” drugs, such as Rohypnol, Gamma Hydroxy Butyrate (GHB) and Ketamine Hydrochloride, being put into a drink.

Several U.S. patents exist for devices that protect open glasses. U.S. Pat. No. 2,500,549 discloses a container cover that includes an adhesive around the periphery to adhere the cover to a glass. U.S. Pat. No. 5,984,135 discloses a container cover that has an adhesive around the periphery to adhere the cover to a glass and an integral drinking straw.

### BRIEF SUMMARY OF THE INVENTION

An object of the present invention is to provide a simple device for protecting the contents of an open glass.

Another object is to provide a glass protection device that can easily be carried.

The present invention is a drinking glass cover that includes a thin film on a carrier. The film is composed of either a material that clings to smooth surfaces or material coated with a weak adhesive and thus remains tight over the opening of a glass. The film is sized so that it extends beyond the rim of the glass and can cling or adhere to the side of the glass. Optionally, the film material either can be pierced by a straw and retain its integrity or has a straw opening. Optionally, the film has a tab for easy removal from the carrier. Optionally, the film is imprinted.

The carrier is a paper, cardboard, or plastic panel to which the film is adhered. Optionally, a plurality of carriers are attached end to end in a roll. Optionally, the carrier has a surface coating or layer that facilitates adherence and/or release by the film. Optionally, the carrier can be designed to be used as a coaster before or after the film is removed. Optionally, the carrier can be imprinted.

Other objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 shows an exploded view of the drinking glass cover of the present invention including optional features; and

FIG. 2 shows a roll of covers of the present invention with optional perforations.

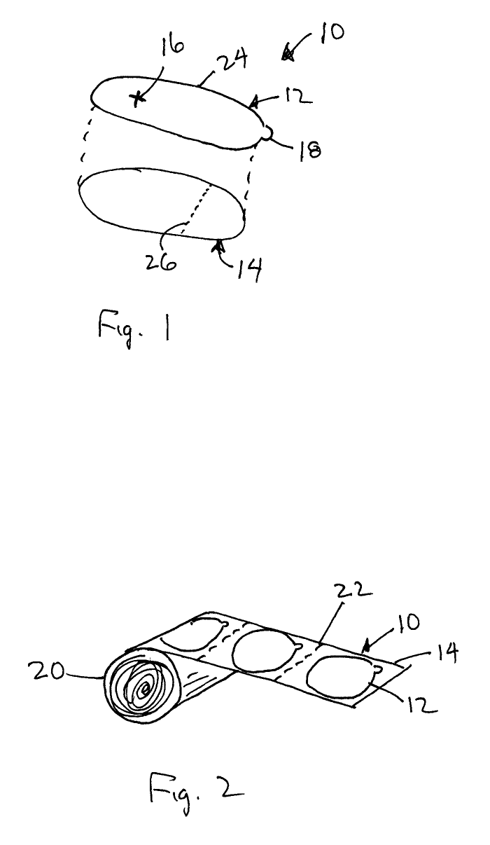

### DETAILED DESCRIPTION OF THE INVENTION

The present invention is a drinking glass cover 10 that includes a thin film 12 on a carrier 14. In one form, the film 12 is composed of a material that clings to smooth surfaces and thus remains tight over the opening of a container without need for an adhesive or other device. One preferred material is a polymer, such as polyvinyl chloride (PVC), polyvinylidene chloride (PVdC), or low density polyethylene (LDPE), which cling well to glass. Other preferred materials cling better to plastic. Other contemplated materials include water-soluble films and dispersible films.

In another form, the film 12 is coated with a weak adhesive that adheres securely to glass and/or plastic, but that can be removed with a minimum of force. The adhesive may cover the entire film 12 or may be limited to the periphery 24 of the film 12. One contemplated adhesive is sold under the brand name GRIPTEX.

Typically, the thickness of the film 12 is in the range of from 0.0001″ (2.5 μm) to 0.010″ (254 μm), but the present invention contemplates that any appropriate thickness can be used. The film 12 can be clear, tinted, translucent and/or opaque.

Typically, the film 12 is round, although the present invention is not limited to any particular shape. The film 12 is sized so that the film 12 extends beyond the rim of the glass and can cling or adhere to the side of the glass. In one form, the film 12 is large enough to cover the majority of glasses that are currently in use. In another form, there are variety of film sizes for the variety of glass sizes.

Optionally, the film 12 is composed of a material that can be pierced by a straw and retain its integrity, that is, the film 12 will continue to cling or adhere to the glass and protect the contents. Optionally, the film 12 has an opening 16 for a straw. The opening 16 may be a hole or it may be a slit or pair of crossed slits that the straw can be pushed through. The slit or crossed slits provide a greater level of protection than the hole since it is not open when a straw is not in the opening 16.

Optionally, the film 12 is composed of a material that is designed to lose its integrity if it is pierced. Assume, for example, that a syringe is used to introduce a substance through the film 12. If the film 12 retained its integrity, the small hole from the syringe may not be noticed. On the other hand, if the film 12 lost its integrity, it would be quickly noticed and the drink can be disposed of.

Optionally, the film 12 has a tab 18 to facilitate easy removal from the carrier 14. Preferably, the tab 18 extends beyond the edge of the carrier 14 when the film 12 is adhered to the carrier 14.

Optionally, the film 12 is imprinted with information, such as advertisements and/or information on the establishment from which the cover 10 was received.

The carrier 14 serves primarily as packaging. The carrier 14 is a planar panel to which the film 12 is adhered. The carrier 14 is composed of a paper material, such as paper or cardboard, or a plastic. Optionally, the carrier 14 has a surface coating or layer that facilitates adherence by the film 12. The surface coating material is determined by the film material. The film 12 can be adhered to the carrier 14 by heat sealing, adhesive, or the cling property of the film 12 itself.

Optional, the carrier 14 is coated with a releasing agent so that the film adhesive will remain on the film 12 when the film 12 is removed from the carrier 14.

Optionally, the carrier 14 is scored in a line 26 to facilitate removal of the film 12 from the carrier 14. The line 26 can be located anywhere on the carrier 14 and there may be more than one line 26. The user bends the cover 10 at the line 26 to split the carrier 14 and then the two parts of the carrier 14 are peeled from the film 12.

Optionally, the carrier 14 is designed to be used as a coaster before or after the film 12 is removed. Optionally, the carrier 14 can be imprinted on one or both sides with information, such as advertisements and/or information on the establishment from which the cover 10 was received.

Optionally and as shown in FIG. 2, the cover 10 is designed to be dispensed from a roll 20. Carriers 14 are attached end to end to form a continuous sheet and, as films 12 are needed, the sheet is pulled from the roll 20 and the films 12 are peeled from the carrier 14. Optionally, the carriers 14 are separated by perforations 22 so that each can be torn from the roll 20, much like a roll of paper towels.

To use the present invention, a user removes the film 12 from the carrier 14 by pulling it from the carrier 14. If the film 12 has a tab 18, the user grasps the tab 18 to pull the film 12 from the carrier 14. If the carrier 14 is scored, the user bends the carrier 14 at the score line 26 and peels the film 12 from the carrier 14. The film 12 is stretched over the top of a glass or plastic cup and smoothed down the side until the film 12 is adhered to the glass or cup to seal the glass opening. If the particular design permits, a straw can be inserted into the straw opening 16 or poked through the film 12.

Thus it has been shown and described a drinking glass cover which satisfies the objects set forth above.

Since certain changes may be made in the present disclosure without departing from the scope of the present invention, it is intended that all matter described in the foregoing specification and shown in the accompanying drawings be interpreted as illustrative and not in a limiting sense.

I claim:

1. A cover for a drinking glass comprising:
(a) a planar carrier; and
(b) a planar film removably attached to said carrier, said film adapted to adhere to said drinking glass after being removed from said carrier.

2. The cover of claim 1 wherein said film includes a tab to facilitate removal of said film from said carrier.

3. The cover of claim 1 wherein said carrier is scored to facilitate removal of said film from said carrier.

4. The cover of claim 1 wherein said film is composed of a polymer.

5. The cover of claim 1 wherein said film is composed of a water-soluble material.

6. The cover of claim 1 wherein said film is composed of a dispersible material.

7. The cover of claim 1 wherein said film is composed of a material that is adapted to adhere to said drinking glass without an adhesive.

8. The cover of claim 1 wherein said film has an adhesive about its perimeter adapted to adhere to said drinking glass.

9. The cover of claim 6 wherein said carrier is coated with a releasing agent.

10. The cover of claim 1 wherein said film retains its integrity when pierced.

11. The cover of claim 1 wherein said film loses its integrity when pierced.

12. The cover of claim 1 wherein said carrier is composed of a paper material.

13. The cover of claim 1 wherein said carrier is adapted to accept imprinting.

14. The cover of claim 1 wherein said film is adapted to accept imprinting.

15. A cover for a drinking glass comprising:
(a) a planar carrier composed of a paper material;
(b) a planar, polymer film removably attached to said carrier;
(c) said film having an adhesive about its perimeter adapted to adhere to said drinking glass after said film is removed from said carrier;
(d) said cover being coated with a releasing agent; and
(e) said cover being scored to facilitate removal of said film from said carrier

16. The cover of claim 15 wherein said film retains its integrity when pierced.

17. The cover of claim 15 wherein said carrier is adapted to accept imprinting.

18. The cover of claim 15 wherein said film is adapted to accept imprinting.

19. A roll of covers for a drinking glass comprising:
(a) a sheet comprised of a plurality of planar carriers attached end to end; and
(b) a planar film removably attached to each of said carriers, said film adapted to adhere to said drinking glass after being removed from said carrier.

20. The roll of covers of claim 19 wherein said carriers are separated by perforations to facilitate removal of a cover from said roll.

21. The roll of covers of claim 19 wherein said film includes a tab to facilitate removal of said film from said carrier.

22. The roll of covers of claim 19 wherein said carriers are scored to facilitate removal of said film from said carrier.

23. The roll of covers of claim 19 wherein said film is composed of a polymer.

24. The roll of covers of claim 19 wherein said film is composed of a water-soluble material.

25. The roll of covers of claim 19 wherein said film is composed of a dispersible material.

26. The roll of covers of claim 19 wherein said film is composed of a material that is adapted to adhere to said drinking glass without an adhesive.

27. The roll of covers of claim 19 wherein said film has an adhesive about its perimeter adapted to adhere to said drinking glass.

28. The roll of covers of claim 27 wherein said carriers are coated with a releasing agent.

29. The roll of covers of claim 19 wherein said film retains its integrity when pierced.

30. The roll of covers of claim 19 wherein said film loses its integrity when pierced.

31. The roll of covers of claim 19 wherein said carriers are composed of a paper material.

32. The roll of covers of claim 19 wherein said carriers are adapted to accept imprinting.

33. The roll of covers of claim 19 wherein said film is adapted to accept imprinting.
